(19) United States
(12) Patent Application Publication
(10) Pub. No.: US 2020/0303774 A1
(43) Pub. Date: Sep. 24, 2020

(54) LITHIUM ION BATTERY USING NON-AQUEOUS ELECTROLYTE

(71) Applicant: SHENZHEN CAPCHEM TECHNOLOGY CO., LTD., Pingshan District Shenzhen (CN)

(72) Inventors: Qiao SHI, Pingshan District Shenzhen (CN); Muchong LIN, Pingshan District Shenzhen (CN); Shiguang HU, Pingshan District Shenzhen (CN); Hailing ZHANG, Pingshan District Shenzhen (CN); Qi GUO, Pingshan District Shenzhen (CN)

(73) Assignee: SHENZHEN CAPCHEM TECHNOLOGY CO., LTD., Pingshan District Shenzhen (CN)

(21) Appl. No.: 16/085,541

(22) PCT Filed: Dec. 29, 2016
(86) PCT No.: PCT/CN2016/113014

§ 371 Date: Sep. 14, 2018

(30) Foreign Application Priority Data
Jul. 8, 2016 (CN) 201610536662.X

(51) Int. Cl. H01M 10/0567; H01M 10/0569; H01M 10/0525; H01M 2/16; H01M 4/583

(52) U.S. Cl. CPC H01M 10/0567; H01M 10/0569; H01M 2004/027; H01M 2/1673; H01M 4/5835; H01M 10/0525

(57) ABSTRACT

Disclosed is a lithium ion battery using a non-aqueous electrolyte. The lithium ion battery comprises a positive electrode, a negative electrode, a separator arranged between the positive electrode and the negative electrode, and a non-aqueous electrolyte of the lithium ion battery. An active substance of the positive electrode comprises LiFePO₄; the non-aqueous electrolyte of the lithium ion battery comprises a non-aqueous organic solvent, a lithium salt and an additive; and the additive at least comprises (A) vinylene carbonate, and at the same time, also comprises at least one of (B) a compound shown in a structural formula 1 and (C) a fluorobenzene, wherein n is a natural number of 1-3, and each of R₁, R₂, R₃ and R₄ is independently selected from one of a hydrogen atom, a fluorine atom, and an alkyl group with 1-6 carbon atoms. The lithium ion battery has a long cycle life, and at the same time, the battery has excellent high and low temperature performance.

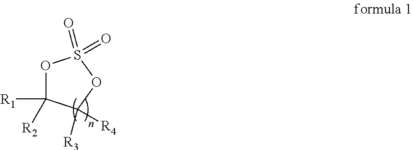

### TECHNICAL FIELD

The present invention relates to the field of lithium-ion battery technology, and particularly to a lithium-ion battery using LiFePO₄ as a cathode active material and including vinylene carbonate as a non-aqueous electrolyte additive.

### BACKGROUND OF THE INVENTION

Lithium-ion batteries have the characteristics of high specific energy, high specific power and long cycling life. Currently, lithium-ion batteries employing a non-aqueous electrolyte have been widely used in 3C consumer electronic products, and with the development of new energy vehicles, such lithium-ion batteries are also becoming more and more common in the field of energy storage and power.

However, with the wide application of lithium-ion batteries, the requirements on their performances become higher. In order to reduce cost, lithium-ion batteries are required to have a higher cycling life; and in order to improve their adaptability to the environment, they are required to have balanced high- and low-temperature performances.

In lithium-ion batteries employing a non-aqueous electrolyte, the non-aqueous electrolyte is a key factor affecting the cycling life and the high- and low-temperature performances of the battery. In particular, the additive in the non-aqueous electrolyte is especially important for achieving the high- and low-temperature performances and the cycling life of the battery. Presently practically used non-aqueous electrolytes use a conventional film-forming additive such as vinylene carbonate (VC) to ensure the cycling performance of the battery. However, the impedance of VC is high, making it difficult to effect the low-temperature performance of the battery. Moreover, as the market demand for battery life becomes more stringent, the use of VC alone cannot meet the requirement for cycling life.

### SUMMARY OF THE INVENTION

The present invention provides a lithium-ion battery with a long cycling life and high- and low-temperature performances, which is realized by the following technical solution:

A lithium-ion battery, comprising a cathode, an anode, a separator disposed between the cathode and the anode, and a non-aqueous electrolyte for lithium ion battery; an active material for the cathode including LiFePO₄; the non-aqueous electrolyte for lithium ion battery comprising a non-aqueous organic solvent, a lithium salt, and an additive; and the additive including at least (A) vinylene carbonate, and further including at least one of (B) a compound represented by Structural Formula 1 and (C) fluorobenzene;

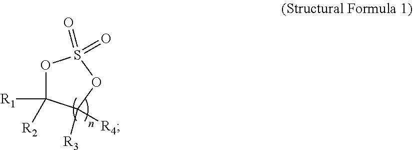

wherein n is a natural number of 1 to 3, and R₁, R₂, R₃ and R₄ are each independently selected from one of hydrogen atom, fluorine atom, and an alkyl group having 1 to 6 carbon atoms.

As a further improvement of the present invention, the additive (A) accounts for 0.2% to 5%, preferably 0.5% to 3% of the total weight of the electrolyte.

As a further improvement of the present invention, the additive (B) accounts for 0.1% to 5%, preferably 0.5% to 3% of the total weight of the electrolyte.

As a further improvement of the present invention, the additive (C) accounts for 0.1% to 20%, preferably 1% to 10% of the total weight of the electrolyte.

As a further improved aspect of the present invention, the compound represented by Structural Formula 1 is ethylene sulfate or 1,3-propanediol sulfate.

As a further improvement of the present invention, the non-aqueous organic solvent is selected from one or more of ethyl methyl carbonate, dimethyl carbonate, diethyl carbonate, ethylene carbonate, propylene carbonate, butylene carbonate, ethylene sulfite, propylene sulfite, diethyl sulfite, γ-butyrolactone, dimethyl sulfoxide, ethyl acetate, methyl acetate, ethyl propionate, methyl propionate or tetrahydrofuran.

As a further improvement of the present invention, the lithium salt is selected from one or more of LiPF₆, LiBF₄, LiSbF₆, LiAsF₆, LiN(SO₂CF₃)₂, LiN(SO₂C2F₅)₂, LiC(SO₂CF₃)₃ or LiN(SO₂F)₂.

As a further improvement of the present invention, the active material for the anode is an artificial graphite.

In addition to the film-forming additive vinylene carbonate (VC), the non-aqueous electrolyte employed in the lithium-ion battery according to the present invention incorporates the low-impedance additive (B) and/or fluorobenzene as an additive for promoting infiltration, which can significantly reduce the impedance of the battery, improve the low-temperature performance of the battery, and also significantly improve the cycling life of the battery.

### DETAILED DESCRIPTION

The present invention will now be described in further detail by way of specific embodiments.

The cathode material for the lithium-ion battery employing a non-aqueous electrolyte according to the present invention is selected to be LiFePO₄. The non-aqueous electrolyte employed in the lithium-ion battery according to the present invention uses vinylene carbonate (VC) as an additive, and further incorporates at least one of a compound represented by Structural Formula 1 and fluorobenzene as an additive, the additives acting synergistically in the same system such that the non-aqueous electrolyte for the lithium-ion battery according to the present invention has a long cycling life and the battery has excellent high- and low-temperature performances.

Vinylene carbonate added in the present invention can form a film on the anode to protect the anode and improve the cycling life of the battery. The content of vinylene carbonate is preferably 0.2% to 5%, more preferably 0.5% to 3% of the total weight of the electrolyte. When the content of vinylene carbonate is less than 0.2%, the film formation is poor, and the battery performances are not desirably improved; while when the content is more than 5%, the film formation at the electrode interface is relatively thick, which would seriously increase battery impedance and degrade battery performances.

The present invention incorporates the compound represented by Structural Formula 1,

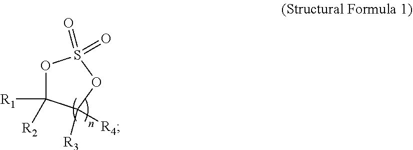

wherein n is a natural number of 1 to 3, and R₁, R₂, R₃ and R₄ are each independently selected from one of hydrogen atom, fluorine atom, and an alkyl group having 1 to 6 carbon atoms.

The compound represented by Structural Formula 1 can lower the impedance of the electrolyte and improve the low-temperature performance and the cycling performance of the battery, without any adverse effect on the high-temperature performance. The content of the compound represented by Structural Formula 1 is preferably 0.1% to 5%, more preferably 0.5% to 3% of the total weight of the electrolyte. When the content of the compound represented by Structural Formula 1 is less than 0.1%, the effect in lowering the impedance of the electrolyte is not marked, and thus the effect in improving the low-temperature performance and the cycling performance of the battery is insufficient; while when the content is more than 5%, there is a side effect on the high-temperature performance.

When the substituents R₁, R₂, R₃ and R₄ in the compound represented by Structural Formula 1 is selected from hydrogen atom, fluorine atom, and an alkyl group having 1 to 6 carbon atoms, they have substantially equivalent impedance property. However, selecting an alkyl group having more than 6 carbon atoms as the substituent may result in a significant change in the impedance property, which is disadvantageous in reducing the impedance of the electrolyte. Therefore, in the present invention, an alkyl group having more than 6 carbon atoms is not selected as the substituent.

In one embodiment of the present invention, ethylene sulfate (DTD) is used as the compound represented by Structural Formula 1, which can provide the battery with a good long cycling life and excellent high- and low-temperature performances. Therefore, the compound represented by Structural Formula 1 may be selected from one or more of ethylene sulfate and 1,3-propanediol sulfate, with ethylene sulfate being the most preferable compound for the present invention.

In a preferred embodiment of the present invention, the addition of fluorobenzene as an additive can promote electrolyte infiltration, improve electrolyte retention, and improve the cycling performance of the battery. The content of fluorobenzene is preferably 0.1% to 20%, more preferably 1% to 10% of the total weight of the electrolyte. When the content of fluorobenzene is less than 0.1%, the effect in promoting electrolyte infiltration is not marked; while when the content is more than 20%, the excess fluorobenzene will polymerize on the cathode, which would increase the impedance of the battery and deteriorate the power of the battery.

In a more preferred embodiment of the present invention, the content of vinylene carbonate is 0.2% to 5% of the total weight of the electrolyte; and the content of the compound represented by the structural formula 1 is 0.1% to 5% of the total weight of the electrolyte.

In a more preferred embodiment of the invention, the content of vinylene carbonate is 0.2% to 5% of the total weight of the electrolyte; and the content of fluorobenzene is 0.1% to 20% of the total weight of the electrolyte.

In a more preferred embodiment of the present invention, the content of vinylene carbonate is 0.2% to 5% of the total weight of the electrolyte; the content of the compound represented by the structural formula 1 is 0.1% to 5% of the total weight of the electrolyte; and the content of fluorobenzene is 0.1% to 20% of the total weight of the electrolyte. In this embodiment, the three additives are in appropriate content ratios such that they can exert their respective properties as fully as possible and produce a significant synergistic effect, leading to excellent cycling life and high- and low-temperature performances of the battery.

In a most preferred embodiment of the present invention, the content of vinylene carbonate is 0.5% to 3% of the total weight of the electrolyte; the content of the compound represented by Structural Formula 1 is 0.5% to 3% of the total weight of the electrolyte; and the content of fluorobenzene is 1% to 10% of the total weight of the electrolyte.

In a preferred embodiment of the invention, the non-aqueous organic solvent is selected from one or more of ethyl methyl carbonate, dimethyl carbonate, diethyl carbonate, ethylene carbonate, propylene carbonate, butylene carbonate, ethylene sulfite, propylene sulfite, diethyl sulfite, γ-butyrolactone, dimethyl sulfoxide, ethyl acetate, methyl acetate, ethyl propionate, methyl propionate or tetrahydrofuran. The selection and amount of these non-aqueous organic solvents can be in accordance with conventional practices in the art.

In a preferred embodiment of the present invention, the lithium salt is selected from one or more of LiPF₆, LiBF₄, LiSbF₆, LiAsF₆, LiN(SO₂CF₃)₂, LiN(SO₂C₂F₅)₂, LiC(SO₂CF₃)₃ and LiN(SO₂F)₂, preferably LiPF₆ or a mixture of LiPF₆ with one or more other lithium salts.

The anode material for the lithium ion battery according to the present invention is preferably an artificial graphite, although other commonly used anode materials can also be selected.

The present invention is described in more detail below by reference to specific examples. It is to be understood that the examples are merely illustrative and are not intended to limit the scope of protection of the present invention.

### Example 1

### 1) Preparation of Electrolyte

Ethylene carbonate (EC), diethyl carbonate (DEC) and ethyl methyl carbonate (EMC) were mixed at a mass ratio of EC:DEC:EMC-1:1:1, then lithium hexafluorophosphate (LiPF₆) was added to a molar concentration of 1 mol/L, and then based on the total mass of the electrolyte, 1% of vinylene carbonate (VC), 0.5% of ethylene sulfate (DTD) and 1% of fluorobenzene were added as additive.

### 2) Preparation of Cathode Plate

LiFePO₄ as cathode active material, Super-P as conductive carbon black and polyvinylidene fluoride (PVDF) as binder were mixed at a mass ratio of 93:4:3. The mixture was dispersed in N-methyl-2-pyrrolidone (NMP) to obtain a cathode slurry. The slurry was uniformly coated onto both sides of an aluminum foil, oven dried, calendered and vacuum dried. Then an aluminum lead wire was welded to the foil by an ultrasonic welder to obtain a cathode plate having a thickness of 120-150 nm.

### 3) Preparation of Anode Plate

Artificial graphite as anode active material, Super-P as conductive carbon black, and styrene butadiene rubber (SBR) and carboxymethyl cellulose (CMC) as binder were mixed at a mass ratio of 94:1:2.5:2.5. The mixture was dispersed in deionized water to obtain an anode slurry. The slurry was coated onto both sides of a copper foil, oven dried, calendered and vacuum dried. Then a nickel lead wire was welded to the foil by an ultrasonic welder to obtain an anode plate having a thickness of 120-150 nm.

### 4) Preparation of Battery Core

A polyethylene microporous film having a thickness of 20 μm was placed as a separator between the cathode plate and the anode plate, and the resulting sandwich structure composed of the cathode plate, the anode plate and the separator was wound. Then, the wound structure was placed into a 26650 aluminum shell cylinder, and baked at 85° C. for 24 hours to obtain a battery core, which was to be injected with the electrolyte.

5) Injection of the Electrolyte into the Battery Core and Battery Formation

In a glove box in which dew point was controlled below −40° C., the electrolyte prepared above was injected into the battery core in an amount such that the electrolyte filled the void in the battery core. Then, battery formation was carried out in the following steps: 0.05C constant-current charging for 120 min, 0.3C constant-current and constant-voltage charging to 3.6V, current being restricted to 0.02C, and 0.5C constant-current discharging to 2.0V.

### 6) Test of Cycling Performance at Ordinary Temperatures

At ordinary temperatures, the battery was charged to 3.6V at a constant-current of 1C and then charged at a constant voltage until the current dropped to 0.02C, followed by being discharged to 2V at a constant-current of 1C. This cycling was repeated for 3000 cycles, and the discharge capacity of the 1st cycle and that of the 3000th cycle were recorded. The capacity retention rate for cycling at ordinary temperatures was calculated as follows:

Capacity retention rate=discharge capacity of the 3000th cycle/discharge capacity of the 1st cycle*100%

### 7) Test of High-Temperature Storage Performance

The formed battery was subjected to 1C constant-current and constant-voltage charging to 3.6V at ordinary temperatures, and the initial discharge capacity of the battery were recorded. Then, the battery was stored at 60° C. for 30 days. Then, after allowing the battery to cool down, the battery was subjected to 1C discharging to 2.0V, then 1C constant-current and constant-voltage charging to 3.6V, and then 1C constant-current discharging to 2.0V, and the battery retention capacity and recovery capacity were recorded. The formulae for calculation are as follows:

Battery capacity retention rate (%)=retention capacity/initial capacity×100%;

Battery capacity recovery rate (%)=recovery capacity/initial capacity×100%;

### 8) Test of Low-Temperature Performance

At 25° C., the formed battery was subjected to 1C constant-current and constant-voltage charging to 3.6V, and then 1C constant-current discharging to 2.0V, and the discharge capacity was recorded. Then, the battery was subjected to 1C constant-current and constant-voltage charging to 3.6V, left to stand in an environment of −20° C. for 12 hours, and then subjected to 1C constant-current discharging to 2.0V, and the discharge capacity was recorded.

Low-temperature discharge efficiency value at −20° C.=1C discharge capacity at −20° C./1C discharge capacity at 25° C.×100%.

### Example 2

As shown in Table 1, this example was the same as Example 1 except that the additive in the preparation of the electrolyte was replaced with 2% of vinylene carbonate (VC), 1% of ethylene sulfate (DTD), and 5% of fluorobenzene. The data of the ordinary-temperature cycling performance, high-temperature storage performance and low-temperature performance obtained in the test are shown in Table 3.

### Example 3

As shown in Table 1, this example was the same as Example 1 except that the additive in the preparation of the electrolyte was replaced with 3% of vinylene carbonate (VC), 3% of ethylene sulfate (DTD), and 10% of fluorobenzene. The data of the ordinary-temperature cycling performance, high-temperature storage performance and low-temperature performance obtained in the test are shown in Table 3.

### Example 4

As shown in Table 1, this example was the same as Example 1 except that the additive in the preparation of the electrolyte was replaced with 5% of vinylene carbonate (VC), 5% of ethylene sulfate (DTD), and 20% of fluorobenzene. The data of the ordinary-temperature cycling performance, high-temperature storage performance and low-temperature performance obtained in the test are shown in Table.

### Example 5

As shown in Table 1, this example was the same as Example 1 except that the additive in the preparation of the electrolyte was replaced with 0.2% of vinylene carbonate (VC), 1% of ethylene sulfate (DTD), and 10% of fluorobenzene. The data of the ordinary-temperature cycling performance, high-temperature storage performance and low-temperature performance obtained in the test are shown in Table 3.

### Example 6

As shown in Table 1, this example was the same as Example 1 except that the additive in the preparation of the electrolyte was replaced with 0.5% of vinylene carbonate (VC), 1% of ethylene sulfate (DTD), and 10% of fluorobenzene. The data of the ordinary-temperature cycling performance, high-temperature storage performance and low-temperature performance obtained in the test are shown in Table 3.

### Example 7

As shown in Table 1, this example was the same as Example 1 except that the additive in the preparation of the electrolyte was replaced with 2% of vinylene carbonate (VC), 0.1% of ethylene sulfate (DTD), and 10% of fluorobenzene. The data of the ordinary-temperature cycling performance, high-temperature storage performance and low-temperature performance obtained in the test are shown in Table 3.

### Example 8

As shown in Table 1, this example was the same as Example 1 except that the additive in the preparation of the electrolyte was replaced with 2% of vinylene carbonate (VC), 5% of ethylene sulfate (DTD), and 10% of fluorobenzene. The data of the ordinary-temperature cycling performance, high-temperature storage performance and low-temperature performance obtained in the test are shown in Table 3.

### Example 9

As shown in Table 1, this example was the same as Example 1 except that the additive in the preparation of the electrolyte was replaced with 2% of vinylene carbonate (VC) and 10% of fluorobenzene. The data of the ordinary-temperature cycling performance, high-temperature storage performance and low-temperature performance obtained in the test are shown in Table 3.

### Example 10

As shown in Table 1, this example was the same as Example 1 except that the additive in the preparation of the electrolyte was replaced with 2% of vinylene carbonate (VC), 1% of ethylene sulfate (DTD) and 0.1% of fluorobenzene. The data of the ordinary-temperature cycling performance, high-temperature storage performance and low-temperature performance obtained in the test are shown in Table 3.

### Example 11

As shown in Table 1, this example was the same as Example 1 except that the additive in the preparation of the electrolyte was replaced with 2% of vinylene carbonate (VC), 1% of ethylene sulfate (DTD), and 20% of fluorobenzene. The data of the ordinary-temperature cycling performance, high-temperature storage performance and low-temperature performance obtained in the test are shown in Table 3.

### Example 12

As shown in Table 1, this example was the same as Example 1 except that the additive in the preparation of the electrolyte was replaced with 2% of vinylene carbonate (VC) and 1% of ethylene sulfate (DTD). The data of the ordinary-temperature cycling performance, high-temperature storage performance and low-temperature performance obtained in the test are shown in Table 3.

### Example 13

As shown in Table 2, this example was the same as Example 1 except that the additive in the preparation of the electrolyte was replaced with 2% of vinylene carbonate (VC), 1% of 1,3-propanediol sulfate, and 5% of fluorobenzene. The data of the ordinary-temperature cycling performance, high-temperature storage performance and low-temperature performance obtained in the test are shown in Table 3.

### Example 14

As shown in Table 2, this example was the same as Example 1 except that the additive in the preparation of the electrolyte was replaced with 2% of vinylene carbonate (VC), 0.1% of 1,3-propanediol sulfate, and 10% of fluorobenzene. The data of the ordinary-temperature cycling performance, high-temperature storage performance and low-temperature performance obtained in the test are shown in Table 3.

### Example 15

As shown in Table 2, this example was the same as Example 1 except that the additive in the preparation of the electrolyte was replaced with 2% of vinylene carbonate (VC), 5% of 1,3-propanediol sulfate, and 10% of fluorobenzene. The data of the ordinary-temperature cycling performance, high-temperature storage performance and low-temperature performance obtained in the test are shown in Table 3.

### Example 16

As shown in Table 2, this example was the same as Example 1 except that the additive in the preparation of the electrolyte was replaced with 2% of vinylene carbonate (VC) and 1% of 1,3-propanediol sulfate. The data of the ordinary-temperature cycling performance, high-temperature storage performance and low-temperature performance obtained in the test are shown in Table 3.

### Comparative Example 1

As shown in Table 1, this example was the same as Example 1 except that the additive in the preparation of the electrolyte was replaced with 2% of vinylene carbonate (VC). The data of the ordinary-temperature cycling performance, high-temperature storage performance and low-temperature performance obtained in the test are shown in Table 3.

### Comparative Example 2

As shown in Table 1, this example was the same as Example 1 except that the additive in the preparation of the electrolyte was replaced with 1% of ethylene sulfate (DTD). The data of the ordinary-temperature cycling performance, high-temperature storage performance and low-temperature performance obtained in the test are shown in Table 3.

### Comparative Example 3

As shown in Table 1, this example was the same as Example 1 except that the additive in the preparation of the electrolyte was replaced with 10% of fluorobenzene. The data of the ordinary-temperature cycling performance, high-temperature storage performance and low-temperature performance obtained in the test are shown in Table 3.

### Comparative Example 4

As shown in Table 1, this example was the same as Example 1 except that the additive in the preparation of the electrolyte was replaced with 1% of ethylene sulfate (DTD) and 10% of fluorobenzene. The data of the ordinary-temperature cycling performance, high-temperature storage performance and low-temperature performance obtained in the test are shown in Table 3.

### Comparative Example 5

As shown in Table 2, this example was the same as Example 1 except that the additive in the preparation of the electrolyte was replaced with 1% of 1,3-propanediol sulfate and 10% of fluorobenzene. The data of the ordinary-temperature cycling performance, high-temperature storage performance and low-temperature performance obtained in the test are shown in Table 3.

Table 1 and Table 2 show the addition of the electrolyte additive in the above examples and comparative examples.

TABLE 1

| | VC | DTD | Fluorobenzene |
|---|---|---|---|
| Example | (%) | (%) | (%) |
| Example 1 | 1 | 0.5 | 1 |
| Example 2 | 2 | 1 | 5 |
| Example 3 | 3 | 3 | 10 |
| Example 4 | 5 | 5 | 20 |
| Example 5 | 0.2 | 1 | 10 |
| Example 6 | 0.5 | 1 | 10 |
| Example 7 | 2 | 0.1 | 10 |
| Example 8 | 2 | 5 | 10 |
| Example 9 | 2 | — | 10 |
| Example 10 | 2 | 1 | 0.1 |
| Example 11 | 2 | 1 | 20 |
| Example 12 | 2 | 1 | — |
| Comparative | 2 | — | — |
| example 1 | | | |
| Comparative | — | 1 | — |
| example 2 | | | |
| Comparative | — | — | 10 |
| example 3 | | | |
| Comparative | — | 1 | 10 |
| example 4 | | | |

TABLE 2

| | | 1,3-propanediol | |
|---|---|---|---|
| | VC | sulfate | Fluorobenzene |
| Example | (%) | (%) | (%) |
| Example 13 | 2 | 1 | 5 |
| Example 14 | 2 | 0.1 | 10 |
| Example 15 | 2 | 5 | 10 |
| Example 16 | 2 | 1 | — |
| Comparative | — | 1 | 10 |
| example 5 | | | |

Table 3 shows the performance data for the above examples and comparative examples.

TABLE 3

| | Capacity | | | |
|---|---|---|---|---|
| | retention rate | | | |
| | after 3000 | | | |
| | cycles of | Storage at | | 1C |
| | ordinary- | 60° C. for 30 days | | discharging |
| | temperature | Retention | Recovery | efficiency at |
| Example | cycling | rate | rate | −20° C. |
| Example 1 | 84.30% | 95.20% | 97.10% | 64.60% |
| Example 2 | 85.50% | 96.30% | 98.50% | 66.20% |
| Example 3 | 84.20% | 96.30% | 98.70% | 64.50% |
| Example 4 | 82.10% | 91.20% | 93.30% | 60.10% |
| Example 5 | 78.20% | 92.40% | 93.50% | 66.00% |
| Example 6 | 80.00% | 94.50% | 95.60% | 66.40% |
| Example 7 | 84.40% | 96.10% | 98.10% | 63.30% |
| Example 8 | 84.50% | 95.20% | 97.40% | 63.80% |
| Example 9 | 84.30% | 96.20% | 98.30% | 63.20% |
| Example 10 | 85.00% | 96.20% | 98.40% | 65.90% |
| Example 11 | 84.70% | 93.20% | 95.40% | 65.80% |
| Example 12 | 84.90% | 96.10% | 98.30% | 65.90% |
| Comparative | 80.10% | 91.00% | 93.20% | 50.00% |
| example 1 | | | | |
| Comparative | 65.20% | 91.30% | 93.60% | 55.20% |
| example 2 | | | | |
| Comparative | 60.30% | 88.40% | 90.40% | 51.50% |
| example 3 | | | | |
| Comparative | 66.10% | 90.80% | 92.40% | 56.30% |
| example 4 | | | | |
| Comparative | 59.80% | 90.60% | 92.20% | 56.10% |
| example 5 | | | | |
| Example 13 | 85.40% | 96.20% | 98.40% | 66.10% |
| Example 14 | 84.50% | 96.00% | 98.00% | 63.40% |
| Example 15 | 84.40% | 95.30% | 97.50% | 63.70% |
| Example 16 | 84.80% | 96.10% | 98.20% | 65.80% |

Comparing the comparative examples with the examples, it was found that by using the combination of vinylene carbonate, ethylene sulfate/1,3-propanediol sulfate and fluorozene as the additive, the non-aqueous electrolyte for the lithium-ion battery according to the present invention had a long cycling life and the battery had excellent high- and low-temperature performances. Such effects were not achievable with currently available non-aqueous electrolytes.

While the above is a further detailed description of the present invention in connection with specific examples, the particular implementation of the present invention should not be deemed to be limited thereto. It will be apparent to those skilled in the art that simple derivations or substitutions are possible without departing from the concept of the present invention and should be regarded as falling into the scope of protection of the present invention.

1. A lithium-ion battery, comprising a cathode, an anode, a separator disposed between the cathode and the anode, and a non-aqueous electrolyte for lithium ion battery; an active material for the cathode including LiFePO₄; the non-aqueous electrolyte for lithium ion battery comprising a non-aqueous organic solvent, a lithium salt, and an additive; and the additive including at least (A) vinylene carbonate, and further including: at least one of (B) a compound represented by Structural Formula 1 and (C) fluorobenzene; 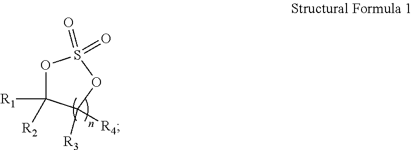
wherein n is a natural number of 1 to 3, and R₁, R₂, R₃ and R₄ are each independently selected from one of hydrogen atom, fluorine atom, and an alkyl group having 1 to 6 carbon atoms.

2. The lithium-ion battery according to claim 1, wherein the additive (A) accounts for 0.2% to 5%, preferably 0.5% to 3% of the total weight of the electrolyte.

3. The lithium-ion battery according to claim 1, wherein the additive (B) accounts for 0.1% to 5%, preferably 0.5% to 3% of the total weight of the electrolyte.

4. The lithium-ion battery according to claim 1, wherein the additive (C) accounts for 0, 1% to 20%, preferably 1% to 10% of the total weight of the electrolyte.

5. The lithium-ion battery according to claim 1, wherein the compound represented by Structural Formula 1 is ethylene sulfate or 1,3-propanediol sulfate.

6. The lithium-ion battery according to claim 1, wherein the non-aqueous organic solvent is selected from one or more of ethyl methyl carbonate, dimethyl carbonate, diethyl carbonate, ethylene carbonate, propylene carbonate, butylene carbonate, ethylene sulfite, propylene sulfite, diethyl sulfite, γ-butyrolactone, dimethyl sulfoxide, ethyl acetate, methyl acetate, ethyl propionate, methyl propionate or tetrahydrofuran.

7. The lithium-ion battery according to claim 1, wherein the lithium salt is selected from one or more of LiPF6, LiBF4, LiSbF6, LiAsF6, LiN(SO2CF3)₂, LiN(SO2C₂F5)₂, LiC(SO2CF3)₃ or LiN(SO2F)₂.

8. The lithium-ion battery according to claim 1, wherein the active material for the anode is an artificial graphite.
